(19) United States
(12) Patent Application Publication
(10) Pub. No.: US 2008/0116685 A1
(43) Pub. Date: May 22, 2008

(54) Helical structure for connecting spray gun and paint cup

(75) Inventor: Y.C. Huang, Hsin Chuang City (TW)

Correspondence Address: BIRCH STEWART KOLASCH & BIRCH, PO BOX 747, FALLS CHURCH, VA, 22040-0747, US

(73) Assignee: CHIA CHUNG PRECISION INDUSTRIAL CO., LTD.

(21) Appl. No.: 11/600,717

(22) Filed: Nov. 17, 2006

(51) Int. Cl. F16L 55/07

(52) U.S. Cl. 285/148.19

(57) ABSTRACT

An innovative “helical structure” for connection of the spray equipment and the paint cup mainly comprises an internal thread connector integrally formed on top of a spray gun and a corresponding external thread connector integrally formed on the connecting section extended from bottom of a paint cup. Connection of the spray gun and the paint cup is made by screwing the external thread connector into the internal thread connector. The characteristic lies in: the multiline threads on the internal thread connector correspond to the single threads on the external thread connector, and both threads share identical thread pitches. The combination of the single thread and multiline threads grants a fast and tight connection of the spray gun and the paint cup. Besides, the single thread is automated adjustable and assures a non-deadlock connection even if it is inclined while being inserted into an open end of the double thread.

### BACKGROUND OF THE INVENTION

I. Field of the Invention

The present invention refers to an improvement on the connecting structure of the paint cup used by spray equipment, particularly to a helical structure that grants fast and tight connection of a spray gun and a paint cup.

II. Description of the Prior Art

With reference to FIG. 4, which is a diagram of the spray equipment of a prior art, the structure mainly comprises a spray gun 41 and a paint cup 42. They are combined into a unit by connecting the internal thread connector 411, which is integrally formed on top of the spray gun 41, and the external thread connector 421,which is integrally formed on the connecting portion extended from bottom of the paint cup 42. The external thread connector must correspond to the internal thread connector. The threads on both the external and internal thread connectors are single threads of small pitch. However, in contrast to the screw connection requirements: the deeper the thread pitch and the more teeth there are, the tighter and smoother the screw connection. It thus requires arduous effort to rotate the paint cup 42 into the spray gun 41. It would be even more difficult to screw off the paint cup 42 when the rim of the connection section of paint cup is stained with paint after use. This is completely impractical for use.

To eliminate the drawbacks of the foregoing prior art, the multiline thread (double thread or triple thread) is recommended. Nevertheless, the structure of the multiline thread is formed by doubling or tripling the parallel single thread so as to reduce the rotations to ½ or ⅔: when the multiline thread's teeth in per inch conform to those of the foregoing prior art, the rotation number can be reduced to ½ or ⅔. Yet, it is very difficult to keep both external and internal threads in coaxial while connecting them to each other, and to simultaneously insert double or triple external threads into open ends of double or triple internal threads. Particularly, the second or third thread may be inclined and inserted into wrong open ends, causing deadlock to connection of the paint cup and the spray gun. Under the circumstances, no tight connection could be achieved. The threads may also be damaged as a result thereof. The connecting structure of the prior art can hardly benefit the user with conveniences.

### SUMMARY OF THE INVENTION

In view of the drawbacks resulted from the connecting structure of a spray gun and a paint cup of the prior art, the present invention is aimed at providing an innovative “helical structure” that can grant firm and tight connection of the paint cup and the spray equipment.

Main objectives of the present invention are to provide a helical structure that grants fast and tight connection of the spray gun and paint cup, and that causes no deadlock even when the external threads are inclined while being inserted into open ends of the internal threads.

To achieve the foregoing objectives, the helical structure of the present invention mainly comprises an internal thread connector integrally formed on top of the spray gun and a corresponding external thread connector integrally formed on the connecting section extended from the bottom of the paint cup. The spray gun and the paint cup are connected to each other by rotating the external thread connector into the internal thread connector. Wherein the characteristic lies in: the internal thread connector comprises the multiline threads that correspond to the single threads on the external thread connector.

According to the foregoing structure, the internal thread connector of the spray gun comprises multiline threads of larger thread pitch and more than two or three open ends. Whereas the external thread connector of the paint cup comprises of single threads, whose thread pitches are identical to those of the internal thread connector, and one start point. The foregoing helical structure combines the single thread and multiline threads to grant fast and tight connection of the spray gun and the paint cup by inserting start point of the single thread on the external thread connector into any open end of the double thread or triple thread on the internal thread connector. Furthermore, the single thread is automated adjustable and assures non-deadlock even if it is inclined while being inserted into an open end of the double thread.

### BRIEF DESCRIPTION OF THE DRAWINGS

FIG. 1 is the diagram of the invention.

FIG. 2 is the enlarged view of a portion of FIG. 1.

FIG. 3A is the sectional view of the internal thread connector of the invention.

FIG. 3B is the sectional view of the external thread connector of the invention.

FIG. 4 is the diagram of the connecting structure of a prior art.

### DESCRIPTION OF THE PREFERRED EMBODIMENT

Desirable features of the present invention will be better understood from the detailed description and drawings that follow, in which an embodiment of the disclosed invention is illustrated by way of example.

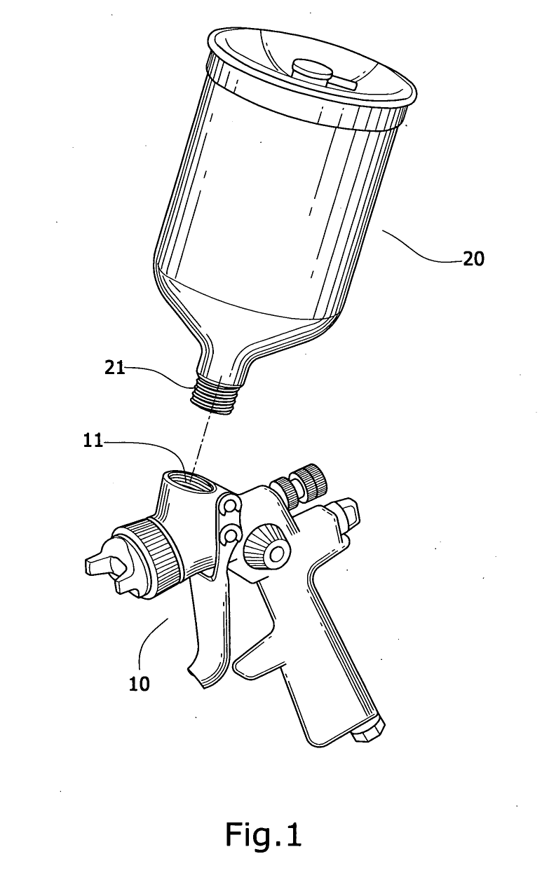

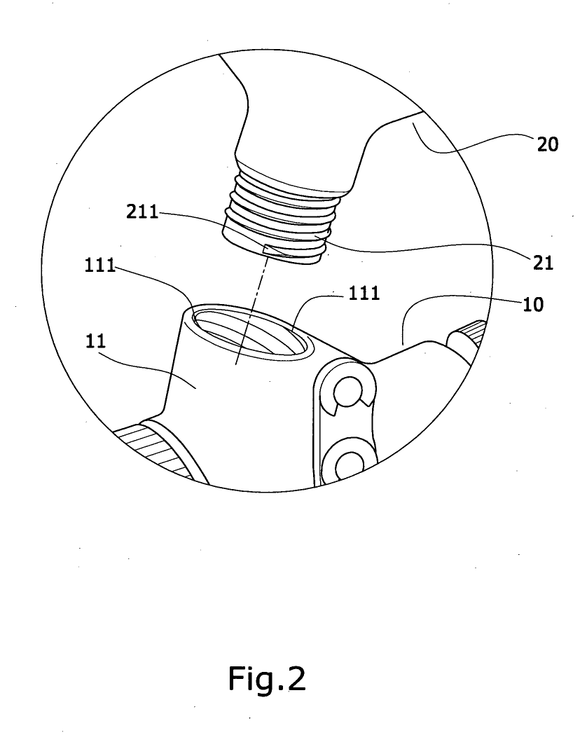

With reference to FIG. 1 and 2, the helical structure of the present invention mainly comprises an internal thread connector 11 (male) integrally formed on top of the spray gun 10 and an external thread connector 21 (female) integrally formed on the connecting portion extended from bottom of the paint cup 20. Double threads on the internal thread connector 11 are tightly fitted with the corresponding single threads on the external thread connector 21.

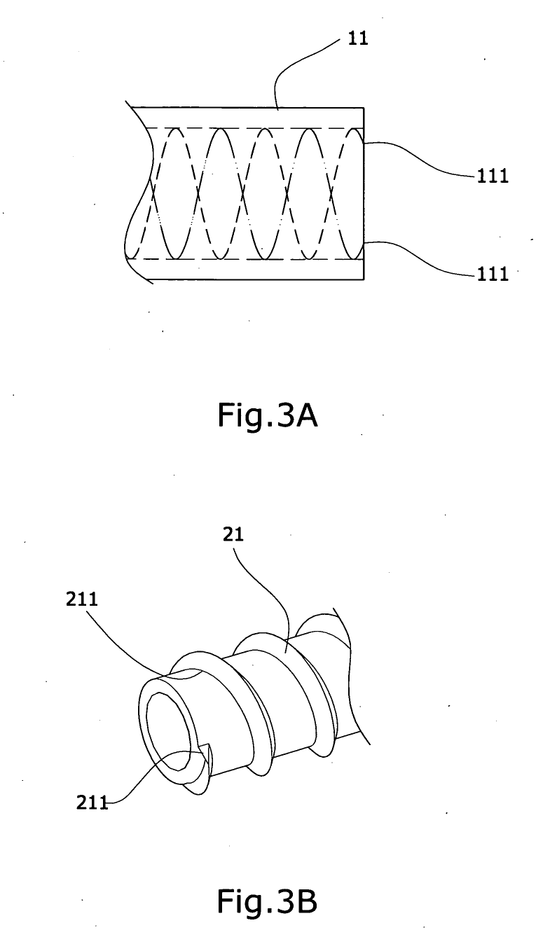

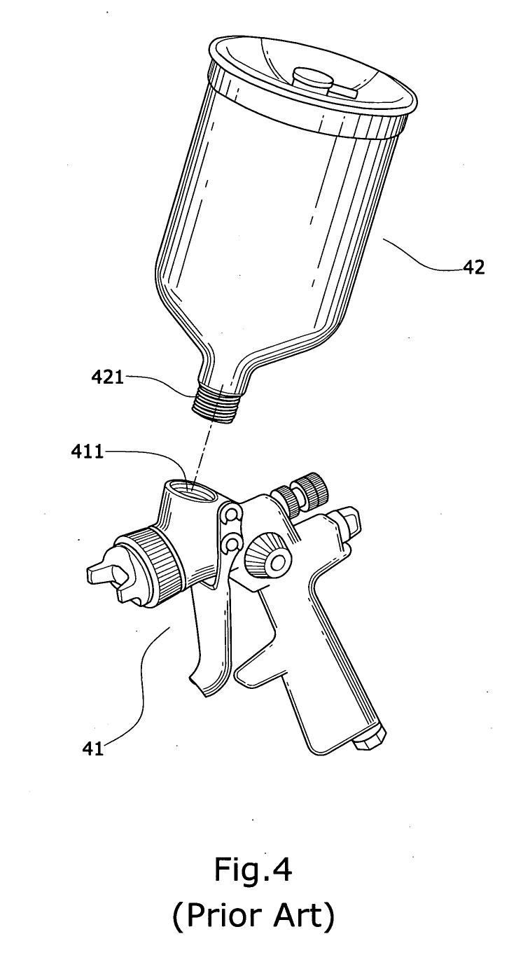

With reference to FIG. 3, the internal thread connector 11 comprises double threads illustrated by two parallel lines, one is dotted and the other segmented. Each thread has thus a larger thread pitch h. The internal thread connector of this embodiment has two open ends 111 corresponding to its double threads as each thread line has an open end 111. However, the thread may be of multiline with multiple open ends, such as the triple thread has three open ends. On the other hand, the external thread connector 21, which is integrally formed on the connecting section extended from the bottom of the paint cup 20, comprises the single thread and one start point 211. However, both internal and external thread connectors share identical thread pitches h so as to assure a tight connection. To connect the two connectors to each other and to the cap and fixture, just insert start point 211 of the single thread on the external thread connector 21 into any of the two open ends 111 of the double thread on the internal thread connector 11. The single thread is automated adjustable. The single thread is automated adjustable and assures a non-deadlock connection even if it is inclined while being inserted into an open end of the double thread. The helical structure of the present invention, which combines single and double threads, successfully assures a tight and firm joint in a flash. Whereas the connecting structure of the prior art that comprises the internal and external thread connectors of identical multiline threads would cause deadlock to the connection.

The single thread on the external thread connector 21 of paint cup 20 is initiated with an inclined rib, the start point 211 (FIG. 2). Such design protects the start point 211 from being deformed by external forces, and makes it easy to be inserted into the open end 111 on the internal thread connector 11 of the spray gun. As a result, the helical structure of the present invention smoothly converts rotary motion into a linear motion.

New characteristics and advantages of the present invention covered by this document have been set forth in the foregoing description. Understanding is sought however, that the drawings are for the purpose of illustration only and not intended to be a definition of the limits of the present invention. Changes in methods, shapes, structures, or devices may be made in detail without exceeding the scope of the invention by those who are skilled and knowledgeable in the field.

To sum up, the “helical structure” of the present invention achieves successfully in fast connection and non-deadlock so as to possess the “practicability” and the “advancement” of the industry. Furthermore, in view that the “helical structure” of the present invention has never been disclosed in any publication or for any application, the present invention conforms to the requirements of the new utility model. This document is, therefore, submitted for applying the patent registration pursuant to the Patent Act.

What is claimed is:

1. An improved helical structure for connecting the spray equipment and the paint cup mainly comprises an internal thread connector integrally formed on top of a spray gun and a corresponding external thread connector integrally formed on connecting section extended from bottom of a paint cup. Connection of the spray gun and the paint cup is made by screwing the external thread connector into the internal thread connector. The characteristic lies in:
the internal thread connector on the spray gun comprises multiline threads;
the external thread connector on the paint cup comprises single threads that correspond to the foregoing double threads;
both single and double threads share identical thread pitches.

2. The helical structure of claim 1, wherein the single thread on the paint cup initiated by a start point, which is an inclined rib served as a guide member.
